(19) United States
(12) Patent Application Publication
(10) Pub. No.: US 2025/0147674 A1
(43) Pub. Date: May 8, 2025

(54) FUNCTIONAL SAFETY SYSTEMS AND METHODS FOR SECURE ACCESS TO NON-VOLATILE MEMORY

(71) Applicant: TEXAS INSTRUMENTS INCORPORATED, Dallas, TX (US)

(72) Inventors: Sai Rajaraman, Frisco, TX (US); Mihir Mody, Bangalore (IN); William Wallace, Richardson, TX (US); Niraj Nandan, Plano, TX (US)

(21) Appl. No.: 18/790,153

(22) Filed: Jul. 31, 2024

Related U.S. Application Data
(60) Provisional application No. 63/547,186, filed on Nov. 3, 2023.

(51) Int. Cl. G06F 3/06

(52) U.S. Cl. CPC G06F 3/0622; G06F 3/0655; G06F 3/0679

(57) ABSTRACT

Various examples disclosed herein relate to controlling access to non-volatile memory devices. In an example embodiment, a device is provided. The device includes a memory security controller configured to operate in a first functional safety mode or a second functional safety mode, a security mode selection controller coupled to the memory security controller, and a memory interface controller coupled to the memory security controller and the security mode selection controller and configured to couple to a non-volatile memory. The security mode selection controller is configured to determine a number of pending access requests associated with the memory security controller, determine a number of incoming responses from the non-volatile memory to the memory security controller, and select between the first functional safety mode and the second functional safety mode based on at least one of the number of pending access requests or the number of incoming responses.

### CROSS-REFERENCE TO RELATED APPLICATIONS

This application claims the priority benefit of U.S. Provisional Patent Application No. 63/547,186, filed Nov. 3, 2023, entitled “METHOD AND SYSTEM FOR FUNCTIONAL SAFETY FOR SECURE ACCESS TO EXTERNAL FLASH,” which is hereby incorporated herein by reference.

### TECHNICAL FIELD

This relates generally to controlling cryptographic processes for secure access to non-volatile memory devices.

### BACKGROUND

Microcontroller units (MCUs) are designed to run software programs and perform functions enabled by running the software programs. To do so, MCUs can include processing cores configured to execute software and memory coupled with the processing cores that stores the instructions and data of the software. For example, MCUs can have one or more central processing units (CPUs), each with any number of processing cores that communicate with volatile memory (e.g., random access memory (RAM)) to execute such software programs. If a software program is too large to be executed from RAM, the MCU may additionally utilize non-volatile memory, such as flash memory, that has a larger capacity to store instructions and data related to the software. MCUs generally execute software programs with greater speed and reduced latency from RAM, however, increasing complexity and size of the programs may require the MCU to execute from volatile memory and/or non-volatile memory to perform the task.

When utilizing non-volatile memory, a processing core may read from or write to a given non-volatile memory. In many existing solutions, data being written to or read from a non-volatile memory may undergo encryption and decryption, respectively, for safety and security purposes. In some of these solutions, such cryptography techniques are required by industry standards (e.g., automotive functional safety standards (e.g., ISO 26262) to protect systems, devices, and users thereof from risks due to hazards caused by malfunctioning computing systems or caused maliciously by attackers.

### SUMMARY

Disclosed herein are improvements to control of safety and security with regards to accessing non-volatile memory. In a computing system, a processing core may attempt to access an external non-volatile memory to read data, write data, or execute program instructions directly from the external non-volatile memory. In such systems, data written to the external non-volatile memory may first be encrypted, and thus, data read from the external non-volatile memory may be decrypted for use by the processing core. A system may employ multiple types of encryption and decryption based on how much capacity is available and based on which elements of the system are more efficient at a given time.

In an example embodiment, a device is provided. The device includes a memory security controller configured to operate in a first functional safety mode or a second functional safety mode, a security mode selection controller coupled to the memory security controller, and a memory interface controller coupled to the memory security controller and the security mode selection controller and configured to couple to a non-volatile memory. The security mode selection controller is configured to determine a number of pending access requests associated with the memory security controller, determine a number of incoming responses from the non-volatile memory to the memory security controller, and select between the first functional safety mode and the second functional safety mode based on at least one of the number of pending access requests or the number of incoming responses.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example system for controlling access to a non-volatile memory device in accordance with an implementation.

FIG. 2 illustrates a series of steps for controlling cryptographic processes and access to memory devices in an implementation.

FIGS. 3A and 3B illustrate example sequence diagrams demonstrating cryptography control and access between elements of a system in accordance with an implementation.

FIG. 4 illustrates an example block diagram of a system configurable to perform memory access and cryptography control in an implementation.

FIG. 5 illustrates an example flow chart for controlling cryptographic processes in an implementation.

FIG. 6 illustrates an example flow chart for performing error testing processes in an implementation.

FIG. 7 illustrates a computing device that may be used in accordance with some examples of the present technology.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

Discussed herein are enhanced components, techniques, and systems related to control of safety and security with regards to accessing non-volatile memory and other types of memory. A processing core can be tasked with executing software to enable functionality of an application, device, or system. While the processing core may copy some code and data to internal memory for execution, it may not be optimal to copy all of the code and data to the internal memory due to design constraints, costs, and other considerations. Thus, non-volatile memory may be included in a system external to the processing core. In such systems, some code and data may be copied from the non-volatile memory to the internal memory (e.g., RAM) at runtime, while other code and data may remain in the external non-volatile memory (e.g., flash memory) at runtime. The processing core may attempt to access both the internal memory and the external memory during execution of software.

In various examples, for safety and security reasons, a system may encrypt information being written to external memory and may decrypt information being read from the external memory. Several cryptographic methods may be employed by a system, and multiple cryptographic methods may be employed by a single system. One example cryptography solution in MCUs uses message authentication code (MAC)-based encryption and decryption techniques to provide integrity protection as well as safety support. However, using MAC-based techniques for all incoming and outgoing data to an external flash may use a significant amount of overhead with respect to non-volatile memory throughput and firmware size. Further, some systems might not require integrity protection for all incoming and outgoing data to and from external memory devices. Another example cryptography solution may use lock-step security techniques to avoid large overhead constraints introduced with MAC-based solutions, such as in systems not requiring integrity protection offered by MAC-based techniques. However, these solutions trade-off overhead with silicon area and design cost. Thus, previous solutions for embedded solutions including MCUs fail to provide a cost-efficient and processing-efficient balance between encryption, decryption, and safe access to and from external memory.

A system disclosed herein includes a safety and security subsystem capable of performing multiple types of cryptography and further capable of switching between functional safety mechanisms for ensuring the encryption and decryption was performed properly. A particular functional safety mechanism may be selected based on system conditions such as whether the security cores or the external memory is incurring more traffic, and thus, may be a bottleneck with respect to throughput, responsiveness, and processing speed and accuracy. Mode selection circuitry may be configured to identify how many commands for encryption or decryption are presented in various queues (e.g., a request queue and/or a command queue) and how many responses are waiting for decryption before being provided to one or more processing cores of the system in various queues (e.g., a response queue). Based on the numbers in each queue relative to respective thresholds, the mode selection circuitry can enable or disable one or more functional safety verification operations (e.g., validation processes applied against outputs from a cryptographic process), which may be beneficial for systems not requiring integrity protection. Advantageously, the system may not only enable a different type of functional safety verification operation for each access request, which may improve system performance and efficiency but also reduce design area space, cost, and throughput losses.

In an example embodiment, a device is provided. The device includes a memory security controller configured to operate in a first functional safety mode or a second functional safety mode, a security mode selection controller coupled to the memory security controller, and a memory interface controller coupled to the memory security controller and the security mode selection controller and configured to couple to a non-volatile memory. The security mode selection controller is configured to determine a number of pending access requests associated with the memory security controller, determine a number of incoming responses from the non-volatile memory to the memory security controller, and select between the first functional safety mode and the second functional safety mode based on at least one of the number of pending access requests or the number of incoming responses.

In another example, a system is provided that includes one or more processing cores, an interconnect coupled to the one or more processing cores, a memory security controller configured to apply cryptographic processes, a security mode selection controller coupled to the memory security controller, and a memory interface controller coupled to the memory security controller and the security mode selection controller and configured to couple to a non-volatile memory. The security mode selection controller may be configured to determine a number of pending access requests associated with the memory security controller, determine a number of incoming responses from the non-volatile memory to the memory security controller, and control which cryptographic functional safety process is applied to at least one of a request or a response based on at least one of the number of pending access requests or the number of incoming responses

In yet another embodiment, a method is provided. The method includes receiving, from one or more processing cores, access requests for data stored in a non-volatile memory device, determining a number of pending access requests of the access requests associated with the non-volatile memory device, determining a number of incoming responses from the non-volatile memory device, and selecting which cryptographic functional safety process to apply to at least one of a request or a response based on at least one of the number of pending access requests or the number of incoming responses.

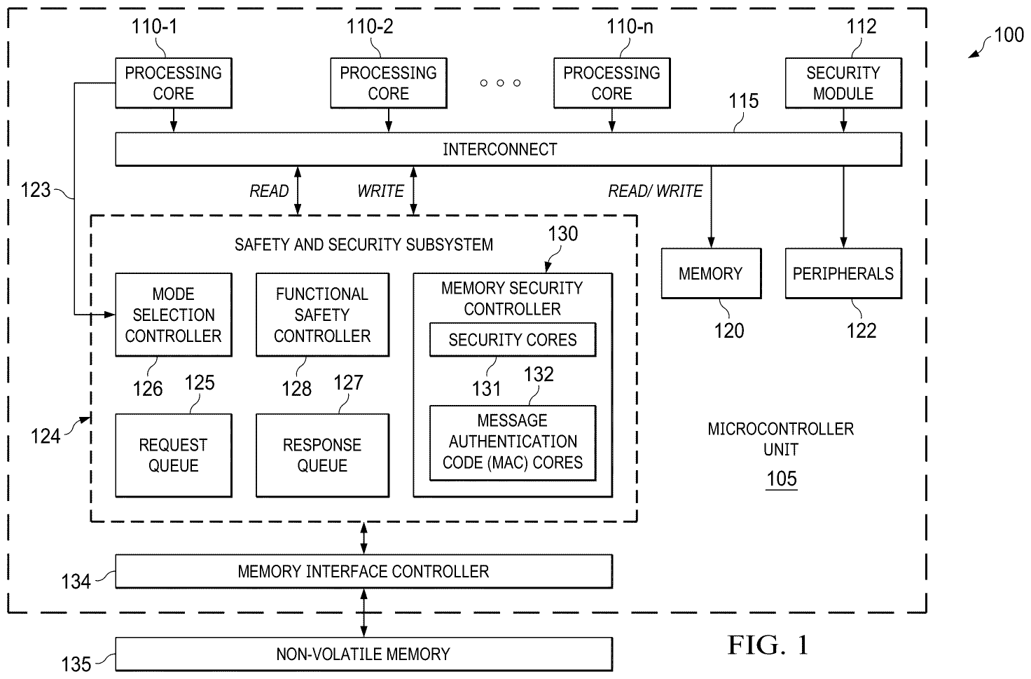

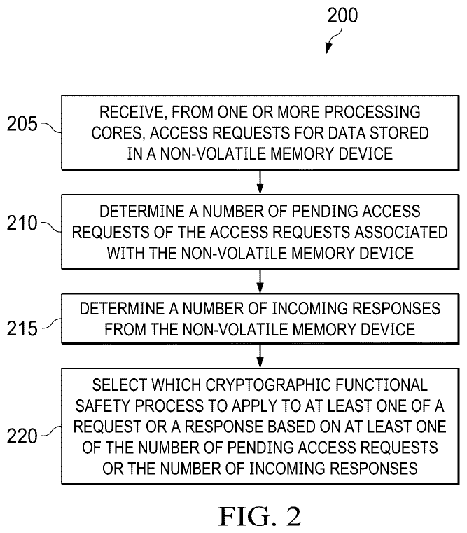

FIG. 1 illustrates an example system for controlling access to a non-volatile memory device in accordance with an implementation. FIG. 1 shows system 100, which includes microcontroller unit (MCU) 105 and non-volatile memory 135. MCU 105 includes processing cores 110-1, 110-2, and 110-n (collectively processing cores 110), security module 112, interconnect 115, memory 120, peripherals 122, safety and security subsystem 124, and memory interface controller 134. Safety and security subsystem 124 includes mode selection controller 126, functional safety controller 128, request queue 125, response queue 127, and memory security controller 130, which further includes security cores 131 and message authentication code (MAC) cores 132. In various embodiments, MCU 105 may be configured to execute program instructions stored in memory 120 and/or non-volatile memory 135 and perform access control processes, such as process 200 of FIG. 2.

In various examples, system 100 is representative of a processing system that includes various hardware, software, and firmware elements configured to execute program instructions and to enable functionality based on the execution thereof. In various examples, the elements of system 100 are onboard a chip (i.e., a system-on-chip (SoC)). In some examples, some elements may be located off-chip relative to other elements onboard the chip, such as non-volatile memory 135. System 100 may be coupled with one or more peripherals 122 that can obtain data from elements of system 100, such as from executions of application code, to enable functionality of the one or more peripheral devices. Like non-volatile memory 135, one or more of the peripheral devices of peripherals 122 may be located off-chip, while one or more other peripheral devices may be located onboard the chip.

System 100 includes MCU 105, which may include various processing devices and memory devices from which program instructions and data can be read and to which program instructions and data can be written. More specifically, MCU 105 may include a number of processing cores 110, a security module 112, an interconnect 115 coupled to the processing cores 110 and the security module 112, a memory device coupled to interconnect 115, memory 120, peripherals 122, safety and security subsystem 124 coupled to the interconnect, and memory interface controller 134 coupled to safety and security subsystem 124 and to non-volatile memory 135.

Processing cores 110 may be representative of one or more processors, processing cores, or processing circuitry capable of executing software and firmware, such as program instructions (e.g., application code, loadable instructions, read-only data, execute-in-place XIP) code, and the like). Such processing core(s) may include microcontrollers, digital signal processors (DSPs), general purpose processing units, central processing units (CPUs), application specific processors or circuits (e.g., ASICs), and logic devices (e.g., FPGAs), as well as other types of processing devices, combinations, or variations thereof. In various examples, processing cores 110 may attempt to access memory 120 and/or non-volatile memory 135 via interconnect 115 to read from or write to a given memory device.

Security module 112 may be representative of a processing core, hardware accelerator, or other processing device configured to perform safety and security operations on data being read from memory 120 by one or more of processing cores 110 or peripherals 122. In various examples, security module 112 may identify a read request by processing cores 110 associated with memory 120, obtain data associated with the read request, and perform a safety and security operation (i.e., encryption, decryption) on the data to verify that the data is not suspicious, malicious, or corrupted.

Memory 120 may be representative of computer-readable storage media located on MCU 105. For example, memory 120 may be representative of a random access memory (RAM), tightly-coupled memory (TCM), or another type of memory. Although only one block is illustrated in system 100, memory 120 may be implemented as multiple memories functioning in an integrated or separate manner. Memory 120 may store program instructions and data. The program instructions may include application code, such as instructions that, when executed by processing cores 110, enable functionality. The data may include results and/or other information related to the program instructions, loadable instructions, XIP code, or the like. Processing cores 110 may access memory 120 via interconnect 115 to execute code thereon.

Some program instructions may be initially stored in non-volatile memory 135 and copied to memory 120 for execution by processing cores 110, whereas XIP code stored on non-volatile memory 135 may be configured to be executed directly out of non-volatile memory 135 without first being copied to memory 120. In executing either set of program instructions, processing cores 110 may attempt to access memory 120 or the non-volatile memory device. An access request, or attempt or command, may refer to a read request whereby processing cores 110 reads instructions or data from one or more addresses of memory 120 or non-volatile memory 135 to perform processing or computations using the instructions or data, or the access attempt may refer to a write request whereby processing cores 110 writes data to one or more addresses of memory 120 or non-volatile memory 135.

Non-volatile memory 135 may be representative of non-volatile computer-readable storage media that retains stored information even after power is removed. In some examples, non-volatile memory 135 may be located externally relative to MCU 105. In some examples, non-volatile memory 135 may be located internally relative to MCU 105. Examples of non-volatile memories 135 and 140 may include FeRAM MRAM, PCM, PRAM, and flash memory. In an example, non-volatile memory 135 may include one or more memory banks included to provide additional capacity to store instructions and data, such as XIP code, read-only data, secondary bootloader data, and other loadable instructions. Non-volatile memory 135 may include a first set of addresses dedicated to storing read-only data and/or secondary bootloader data, a second set of addresses dedicated to storing data written to non-volatile memory 135 by processing cores 110 via memory interface controller 134, and a third set of addresses dedicated to storing program instructions. Other architectures may be contemplated for non-volatile memory 135. In some examples, non-volatile memory 135 may include another type of non-volatile memory or combinations or variations thereof.

Safety and security subsystem 124 may be representative of a subsystem or module including one or more components configured to provide processing cores 110 with access to non-volatile memory 135 via memory interface controller 134 for the execution of application code thereon as well as encryption and decryption of information (e.g., data, program instructions) being passed to and from non-volatile memory 135 via memory interface controller 134. In an example, safety and security subsystem 124 may include one or more processors, processing cores, processing circuits, or hardware accelerators (HWAs) that includes hardware elements coupled to receive access requests (e.g., reads, writes) from processing cores 110, receive responses based on the access requests from non-volatile memory 135 via memory interface controller 134, and perform cryptographic operations on access requests to non-volatile memory 135 and returned access requests, or responses thereto, from non-volatile memory 135. Memory interface controller 134 may be representative of a device configured to route the access requests to physical address spaces of non-volatile memory 135 based on the access requests and provide access to non-volatile memory 135 at the physical addresses. In some examples, memory interface controller 134 may include a flash interface controller based on non-volatile memory 135 including a flash memory. The elements included in safety and security subsystem 124 may include mode selection controller 126, functional safety controller 128, memory security controller 130, and request queue 125 and response queue 127, which may be accessible by each of the aforementioned elements.

Mode selection controller 126 may be representative of one or more processors, circuits, or devices coupled to both functional safety controller 128 and to memory security controller 130 to control operations thereof. More specifically, mode selection controller 126 may be configured to identify a current state (e.g., enabled, disabled) of functional safety controller 128 and memory security controller 130, identify a number of access requests being processed by functional safety controller 128 and/or memory security controller 130 in request queue 125, identify a number of responses being processed by functional safety controller 128 and/or memory security controller 130 in response queue 127, and enable or disable operations of functional safety controller 128 and memory security controller 130 based on system conditions, such as the numbers of access requests and responses in respective queues and the current operations thereof.

For example, in a first mode (e.g., double pump mode), functional safety controller 128 may be configured to perform duplication, filtering, and validation operations to enable functional safety of outgoing requests to non-volatile memory 135 and incoming responses based on the outgoing requests from non-volatile memory 135. In the first mode, security cores 131 may be configured to perform cryptography operations on each copy of duplicated requests and responses, and functional safety controller 128 may be configured to validate results of the cryptography operations performed by security cores 131. In a second mode (e.g., MAC mode), duplication and filtering functionality of functional safety controller 128 may be disabled, and message authentication code (MAC) cores 132 cores may be enabled to perform MAC cryptography operations on the requests and responses in addition to the cryptography operations performed by security cores 131. Functional safety controller 128 may thus be configured to validate results of both cryptography operations in the second mode.

Functional safety controller 128 and memory security controller 130 may be representative of safety and security related circuits capable of enabling and performing cryptographic operations on access requests from processing cores 110 and responses, based on the access requests, from non-volatile memory 135. When enabled, functional safety controller 128 may be configured to duplicate access requests, provide the duplicated access requests to request queue 125 and to memory security controller 130, validate each copy of the duplicated access request against each other based on comparing request-related information of the duplicated access requests (e.g., validating that the duplicated requests include the same information, such as addresses, size, protocol-specific parameters, and the like), filter the duplicated access requests received from memory security controller 130 based on the validation, and provide the access requests to memory interface controller 134 for access to non-volatile memory 135. Further, functional safety controller 128 may be configured to receive responses, based on the access requests, from non-volatile memory 135 via memory interface controller 134, duplicate the responses and add the duplicated responses to response queue 127, provide the duplicated responses to memory security controller 130 for decryption thereof in accordance with a selected cryptography mode, validate the decryption of each copy of the duplicated response based on comparing response-related information (e.g., validating that the duplicated responses include the same information, such as data, size, and the like), filter the duplicated decrypted responses received from memory security controller 130 following decryption and validation, and provide decrypted responses to processing cores 110 via interconnect 115. In some examples, in the second mode, functional safety controller 128 might not be disabled, but the duplication and filtering operations may be bypassed to conserve power and increase throughput, for example.

To perform encryption and decryption operations, memory security controller 130 may include security cores 131 and MAC cores 132. Security cores 131 may be representative of one or more processing cores, circuits, or devices capable of encrypting data to be written to non-volatile memory 135 and decrypting data of a response from non-volatile memory 135. Similarly, MAC cores 132 may be representative of one or more processing cores, circuits, or devices capable of performing MAC encryption and decryption when memory security controller 130 is enabled to operate in the second mode. In various examples, MAC cores 132 may perform MAC encryption on some or all of the write requests including information to be written to non-volatile memory 135 regardless of the selected mode. In various examples, memory security controller 130, or the cores thereof, may be controlled by mode selection controller 126 to enable or disable verification operations applied to outputs of MAC cores 132 such that MAC functional safety operations may be enabled or disabled, respectively, on the access requests and responses.

To determine whether to enable the first or the second mode for ensuring functional safety of the cryptography, mode selection controller 126 may be configured to determine a number of pending access requests associated with memory security controller 130, or respective cores thereof, in request queue 125 during a given mode and determine a number of incoming responses from non-volatile memory 135 to memory security controller 130 in response queue 127. Each incoming response may correspond to an access request of the pending access requests. Based on the number of pending access requests and incoming responses in request queue 125 and response queue 127, respectively, mode selection controller 126 can determine whether non-volatile memory 135 may be slowing down overall operations of MCU 105 (i.e., is a bottleneck) or whether memory security controller 130 or functional safety controller 128 may be slowing down operations of MCU 105 (i.e., is a bottleneck). For example, if the number of pending access requests exceeds a threshold number, mode selection controller 126 may determine that non-volatile memory 135 and memory interface controller 134 might not be processing the access requests and providing responses to the access requests fast enough, such that non-volatile memory 135 and memory interface controller 134 are reducing processing efficiency, responsiveness, throughput, and the like of MCU 105. Thus, mode selection controller 126 may disable the second mode (MAC mode) and may enable the first mode (double pump mode). Contrarily, if the number of incoming responses exceeds a threshold number, mode selection controller 126 may determine that memory security controller 130 and functional safety controller 128 might not be processing (e.g., duplicating, filtering) and decrypting the access responses fast enough, such that memory security controller 130 and functional safety controller 128 are reducing processing efficiency, responsiveness, throughput, and the like of MCU 105. Thus, mode selection controller 126 may disable the first mode and enable the second mode of safety and security subsystem 124. In the first mode, safety and security subsystem 124 may take longer to perform functional safety operations (e.g., duplicating, validating, and filtering access requests, and duplicating, decrypting, validating, and filtering corresponding responses) than in the second mode. In this way, by controlling the mode of cryptography and validation thereof via functional safety controller 128 and memory security controller 130, mode selection controller 126 can dynamically balance the loads of the components of safety and security subsystem 124 and MCU 105 to increase performance and reduce latency due to bottlenecking.

In some examples, mode selection controller 126 may be configured to control which mode to enable or disable based on selection signal 123, indicative of a mode of cryptographic functional safety, provided to mode selection controller 126 by processing core 110-1. In some such examples, processing core 110-1 may provide selection signal 123 to mode selection controller 126 during a boot or start-up sequence. In some such examples, processing core 110-1 may provide selection signal 123 to mode selection controller 126 at a time before or at the beginning of a run-time sequence following boot-up of MCU 105 and components thereof. In some such examples, processing core 110-1 may provide selection signal 123 to mode selection controller 126 based on execution of program instructions. In some such examples, processing core 110-1 may provide selection signal 123 to mode selection controller 126 after a number of processing cycles.

In some examples, mode selection controller 126 may be configured to enable the first mode by default. In some examples, mode selection controller 126 may be configured to enable the second mode by default. In some examples, mode selection controller 126 may override the mode based on receiving selection signal 123. Regardless of the method of implementation, mode selection controller 126 may be configured to use a mode for a given access request and for a corresponding response to the given access request.

By way of a first example, in operation, processing core 110-1 provides an access request to safety and security subsystem 124 via interconnect 115 corresponding to a write request, indicating a first set of data, to non-volatile memory 135. In this first example, safety and security subsystem 124 may be configured to operate in the first mode. In some examples, based on the access request including a write request, functional safety controller 128 might not be configured to perform duplication operations on the write request, but rather, provide the write request to security cores 131 for encryption thereof and forwarding of the encrypted write request to memory interface controller 134 for writing of the first set of data to non-volatile memory 135. In some examples, functional safety controller 128 may be configured to perform duplication, validation, and filtering operations on the write requests. In some such examples, functional safety controller 128 may be configured to duplicate the write request and add both write requests to request queue 125, which may in turn provide the write request to security cores 131 of memory security controller 130 based on the first mode being enabled. Security cores 131 may be configured to encrypt both write requests and provide the encrypted write requests to functional safety controller 128 for validation and filtering thereof. Functional safety controller 128 can validate the encryption of the write requests, filter out (e.g., discard, not provide) one of the write requests based on successful validation, and provide one of the write requests to memory interface controller 134 for writing of the first set of data to non-volatile memory 135.

Following the first example, processing core 110-1 may subsequently provide an access request to safety and security subsystem 124 via interconnect 115 corresponding to a read request indicating the first set of data. Based on being enabled to operate in the first mode, functional safety controller 128 may be configured to receive a response from non-volatile memory 135 via memory interface controller 134 corresponding to the read request for the first set of data, duplicate the response, and add both responses to response queue 127. Memory security controller 130 may be configured to obtain the responses, decrypt both responses via security cores 131, and provide the decrypted responses to functional safety controller 128. Functional safety controller 128 may be configured to validate the decryption based on comparing the decrypted responses to each other. In some examples, this may entail comparing the data included in the responses, the size of the data in each response, and the like. Based on successful decryption and validation thereof, functional safety controller 128 may filter out one of the responses and provide the other to processing core 110-1. Based on unsuccessful decryption and validation, such as when the information of one response does not match the information of the other response, functional safety controller 128 may provide an indication thereof to processing core 110-1.

In a second example, processing core 110-1 provides an access request to safety and security subsystem 124 via interconnect 115 corresponding to a write request, indicating a second set of data, to non-volatile memory 135. In this second example, safety and security subsystem 124 may be configured to operate in the second mode. Based on the second mode, functional safety controller 128 may be configured to add the write request to request queue 125 without duplication thereof. Memory security controller 130 may obtain the write request from request queue 125 and perform encryption thereof via security cores 131. Further, based on the second mode, memory security controller 130 may be configured to perform MAC encryption on the write request via MAC cores 132. In this way, security cores 131 may encrypt the second set of data, and MAC cores 132 may add MAC information to the encrypted second set of data. In some examples, the encrypted request may include 32 bytes of data, and the MAC information may include 16 bytes of data, thus, the encrypted request may include 48 total bytes of data. Memory security controller 130 may provide the encrypted request to functional safety controller 128 for validation of the encryption. Functional safety controller 128 may provide the encrypted request to memory interface controller 134 for writing of the second set of data to non-volatile memory 135.

Following the second example, processing core 110-1 may subsequently provide an access request to safety and security subsystem 124 via interconnect 115 corresponding to a read request indicating the second set of data. Based on being enabled to operate in the second mode, functional safety controller 128 may be configured to receive a response from non-volatile memory 135 via memory interface controller 134 corresponding to the read request for the second set of data and the response to response queue 127 without duplication thereof. Memory security controller 130 may be configured to obtain the response, decrypt the response via security cores 131, perform MAC validation of the MAC information of the decrypted response via MAC cores 132, and provide the decrypted response to functional safety controller 128. Functional safety controller 128 may be configured to validate the decryption based on comparing the decrypted data to the second set of data and validate the MAC information (e.g., a MAC value) based on comparing the MAC information received from non-volatile memory 135 to the MAC information added to the outgoing request to non-volatile memory 135. Based on successful decryption and validation thereof, functional safety controller 128 may provide the second set of data to processing core 110-1. Based on unsuccessful decryption and validation, such as when the incoming MAC information does not match the outgoing MAC information, functional safety controller 128 may provide an indication thereof to processing core 110-1.

Between the time that processing core 110-1 provides the read request and the corresponding write request that both relate to the first set of data as in the first example, safety and security subsystem 124 may perform cryptographic processes on other access requests related to different data (e.g., the access requests related to the second set of data as in the second example). Before processing these other access requests, mode selection controller 126 may be configured to determine a number of pending access requests in request queue 125, determine a number of pending responses in response queue 127, and control the mode of functional safety controller 128 and memory security controller 130 based on the determined numbers relative to respective thresholds. Thus, the mode of safety and security subsystem 124 may change one or more times for processing of the other access requests occurring between the read and write requests of the first example. Other combinations or variation of access requests, responses, and mode switching to enable different cryptographic operations may be contemplated.

In various examples, regardless of the mode of operation, memory security controller 130 may be configured to encrypt data to be written to non-volatile memory 135 using both security cores 131 and MAC cores 132 such that each set of encrypted data written to non-volatile memory 135 includes MAC information associated with the encrypted data.

In various examples, non-volatile memory 135 may further provide error checking indications to MCU 105 via memory interface controller 134, which may be provided to processing cores 110 via interconnect 115. Upon receiving an indication, such as an interrupt indication, processing core 110-1 may provide a selection signal 123 to mode selection controller 126 to enable or disable a mode of functional safety controller 128 and memory security controller 130.

These examples discuss only a few situations and a few types of access requests, however, combinations and variations of requests for access to different types of memory and using different types of encryption and decryption techniques may be contemplated. Regardless of type of memory, the addresses attempted to be accessed, the type of cryptography, and the like, mode selection controller 126 can switch between two or more types of cryptographic functional safety methods to ensure that requests and responses thereto are performed in an order that at least increases processing efficiency and throughput of processing cores 110 and MCU 105 while also reducing latency caused by bottlenecking.

FIG. 2 illustrates a series of steps for controlling cryptographic processes and access to memory devices in an implementation. FIG. 2 shows process 200, which references elements of FIG. 1. Process 200 may be implemented by one or more components of a processing system, such as MCU 105 of FIG. 1. Accordingly, process 200 may be implemented in hardware, firmware, and/or software, or combinations or variations thereof.

In operation 205, safety and security subsystem 124 may be configured to receive, from one or more of processing cores 110, access requests for data stored in non-volatile memory 135. An access request may refer to a read request whereby processing cores 110 reads instructions or data from one or more addresses of memory 120 or non-volatile memory 135 to perform processing or computations using the instructions or data, or the access attempt may refer to a write request whereby processing cores 110 writes data to one or more addresses of memory 120 or non-volatile memory 135. Safety and security subsystem 124 may include various components, such as mode selection controller 126, functional safety controller 128, and memory security controller 130, coupled to receive the access requests from the one or more processing cores, apply cryptographic techniques on the access requests, and provide the access requests to memory interface controller 134 for access to non-volatile memory 135. Specifically, functional safety controller 128 may be coupled to receive the access requests from one or more of processing cores 110 via interconnect 115.

Next, in operation 210, safety and security subsystem 124, or mode selection controller 126 thereof, may be configured to determine a number of pending access requests associated with non-volatile memory 135 in request queue 125. A pending access request may refer to an access request in an access request queue waiting to be encrypted or decrypted by memory security controller 130. In operation 215, safety and security subsystem 124, or mode selection controller 126 thereof, may be configured to determine a number of incoming responses from non-volatile memory 135 in response queue 127. An incoming response may refer to a response provided to safety and security module 124 from non-volatile memory 135 via memory interface controller 134 based on an access request. More specifically, the incoming response may include data or program instructions requested in an access request following the access of non-volatile memory 135 via memory interface controller 134. Each incoming response may be associated with a given access request. Each incoming response may be indicated in response queue 127. Accordingly, mode selection controller 126 may identify the number of incoming responses in the response queue 127 during this step.

In various examples, memory security controller 130 may perform encryption or decryption operations on contents of pending access requests in the request queue 125 and pending responses in response queue 127 in a first-in first-out (FIFO) basis. Memory security controller 130 may include security cores 131 and MAC cores 132, which may perform cryptography operations on the requests and responses thereto. For example, security cores 131 may be configured to perform encryption on access requests and decryption on corresponding responses in both a first mode and a second mode configured by mode selection controller 126. MAC cores 132 may be configured to perform MAC encryption on access requests encrypted by security cores 131 and MAC decryption on responses decrypted by security cores 131 in the second mode configured by mode selection controller 126. In some examples, MAC cores 132 may also perform MAC encryption on access requests in the first mode. In some examples, functional safety controller 128 may perform different functional safety validation operations on the encrypted and/or decrypted requests and responses based on a selected mode.

In operation 220, safety and security subsystem 124, or mode selection controller 126 thereof, may be configured to select which cryptographic functional safety process to apply to validate cryptographic operations applied to at least one of the pending access requests or the corresponding incoming responses based on at least one of the number of pending access requests in request queue 125 or the number of incoming responses in the response queue 127. In various examples, this may entail determining, based on the numbers of pending access requests and incoming responses, whether non-volatile memory 135 may be slowing down overall operations of MCU 105 (i.e., is a bottleneck) or whether memory security controller 130 or functional safety controller 128 may be slowing down operations of MCU 105 (i.e., is a bottleneck). For example, mode selection controller 126 may compare the numbers to respective threshold numbers. If the number of pending access requests exceeds a threshold number, mode selection controller 126 may determine that non-volatile memory 135 and memory interface controller 134 might not be processing the access requests and providing responses to the access requests fast enough, such that non-volatile memory 135 and memory interface controller 134 are reducing processing efficiency, responsiveness, throughput, and the like of MCU 105. Thus, mode selection controller 126 may disable the second mode operations (MAC cryptographic functional safety) and enable the first mode operations (double pump cryptographic functional safety). Contrarily, if the number of incoming responses exceeds a threshold number, mode selection controller 126 may determine that memory security controller 130 and functional safety controller 128 might not be processing (e.g., duplicating, filtering) and decrypting the responses fast enough, such that memory security controller 130 and functional safety controller 128 are reducing processing efficiency, responsiveness, throughput, and the like of MCU 105. Thus, mode selection controller 126 may disable first mode operations of functional safety controller 128 and memory security controller 130 and enable second mode operations thereof.

In the first mode, duplication and filtering functional safety operations of functional safety controller 128 may be enabled. In this way, security cores 131 of memory security controller 130 may be used to encrypt and/or decrypt multiple access requests and responses, respectively, and functional safety controller 128 may validate the encryption and/or decryption thereof based on comparing the results of the cryptographic operations performed on the multiple requests and responses. In the second mode, duplication and filtering functional safety operations of functional safety controller 128 may be disabled. As such, security cores 131 may be used to encrypt and/or decrypt individual access requests and responses, and MAC cores 132 may be used to add MAC information to the encrypted requests and validate MAC information of the decrypted responses. In the first mode, based on performing double pump techniques, safety and security subsystem 124 may take longer to perform cryptographic functional safety operations on access requests and corresponding responses than in the second mode as twice the number of requests and responses may be encrypted and decrypted, respectively. In this way, by controlling the mode of cryptography via functional safety controller 128 and memory security controller 130, mode selection controller 126 can dynamically balance the loads of the components of safety and security subsystem 124 and MCU 105 to increase performance and reduce latency due to bottlenecking.

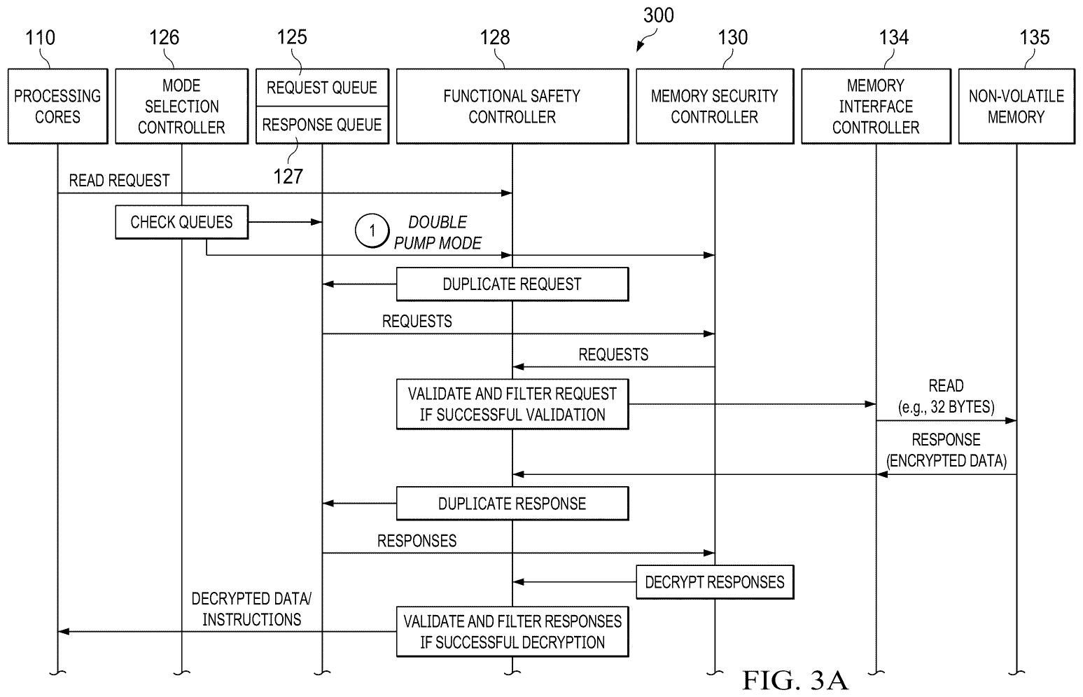

FIGS. 3A and 3B illustrate example sequence diagrams demonstrating cryptography control and access between elements of a system in accordance with an implementation. FIG. 3A shows sequence 301, and FIG. 3B shows sequence 302, both of which reference elements of system 100.

Sequences 301 and 302 may include operations performed by elements of system 100 with respect to read requests from one or more of processing cores 110, such as processing core 110-1. In some sequences related to write requests, the elements of system 100 may perform cryptographic functional safety operations to encrypt data being written to non-volatile memory and to validate the encryption thereof based on a selected mode enabled by mode selection controller 126.

In sequence 301, processing core 110-1 provides an access request to safety and security subsystem 124, or to functional safety controller 128 thereof, via interconnect 115 corresponding to a read request that indicates a first set of data stored in non-volatile memory 135. Before the read request is performed by memory interface controller 134, mode selection controller 126 of safety and security subsystem 124 may be configured to determine a number of pending access requests associated with non-volatile memory 135 in request queue 125 and a number of incoming responses from non-volatile memory 135 in response queue 127 to determine a mode of cryptographic functional safety in which to enable components of safety and security subsystem. Based on request queue 125 and response queue 127, mode selection controller 126 may be configured to enable a first mode of cryptographic operations (double pump cryptographic functional safety) and provide an indication of the first mode to functional safety controller 128 and to memory security controller 130.

Based on the indication of the first mode, functional safety controller 128 may be configured to duplicate the read request and provide the duplicated read requests to request queue 125. Memory security controller 130 may be configured to obtain the read requests from request queue 125. Memory security controller 130 may be configured to identify the indication of the first mode. Functional safety controller 128 may then be configured to validate the duplication of the read requests based on comparing information of each of the read requests. If functional safety controller 128 confirms that the information of each read request matches, functional safety controller 128 may filter out one of the read requests and provide the read request to memory interface controller 134 for access of non-volatile memory 135 based on the read request.

Next, functional safety controller 128 may be configured to obtain a response from non-volatile memory 135 via memory interface controller 134 including the first set of encrypted data. Functional safety controller 128 can duplicate the response and add the responses to response queue 127. Security cores 131 of memory security controller 130 may be configured to receive the duplicated responses from response queue 127. Security cores 131 can decrypt both responses based on the first mode being enabled and provide the sets of decrypted data to functional safety controller 128. Then, functional safety controller 128 can validate whether the decryption of the responses was successful. In various examples, this may entail comparing information of each decrypted response, such as the sizes of the responses, the data of the responses, and the like. Based on successful decryption, functional safety controller 128 can filter the duplicated, decrypted responses and provide the first set of decrypted data to processing core 110-1 via interconnect 115. Based on unsuccessful decryption, functional safety controller 128 may be configured to output an indication thereof to processing cores 110.

In sequence 302, processing core 110-1 provides an access request to safety and security subsystem 124, or to functional safety controller 128 thereof, via interconnect 115 corresponding to a read request that indicates a second set of data stored in non-volatile memory 135. Prior to the read request being performed by memory interface controller 134, mode selection controller 126 of safety and security subsystem 124 may be configured to determine a number of pending access requests associated with non-volatile memory 135 in request queue 125 and a number of incoming responses from non-volatile memory 135 in response queue 127 to determine a mode of cryptographic functional safety in which to enable components of safety and security subsystem. Based on request queue 125 and response queue 127, mode selection controller 126 may be configured to enable a second mode of cryptographic operations (MAC cryptographic functional safety) and provide an indication of the second mode to functional safety controller 128 and to memory security controller 130.

In the second mode, duplicating and filtering operations of functional safety controller 128 may be disabled. Rather, functional safety controller 128 may be configured to add the read request to request queue 125 without duplicating the request. Memory security controller 130 may obtain the read request from request queue 125 and provide the read request to memory interface controller 134 for access of non-volatile memory 135 based on the read request.

Next, functional safety controller 128 may be configured to obtain a response from non-volatile memory 135 via memory interface controller 134 including the second set of encrypted data. Functional safety controller 128 can add the response to response queue 127 without duplicating the response. Memory security controller 130 may be configured to obtain the response from response queue 127. Security cores of memory security controller 130 may be configured to decrypt the response and provide the decrypted response to MAC cores 132 of memory security controller 130 based on the second mode being enabled. MAC cores 132 can validate the MAC information of the decrypted response based on comparing the MAC information received from non-volatile memory 135 to the MAC information used to encrypt the second set of data. Based on successful validation of the MAC information and information of the response, memory security controller 130 may be configured to provide the response to processing core 110-1 via interconnect 115. Based on an unsuccessful validation, such as if the MAC information of the response does not match the MAC information used to encrypt the second set of data, memory security controller 130 may output an indication thereof to processing cores 110.

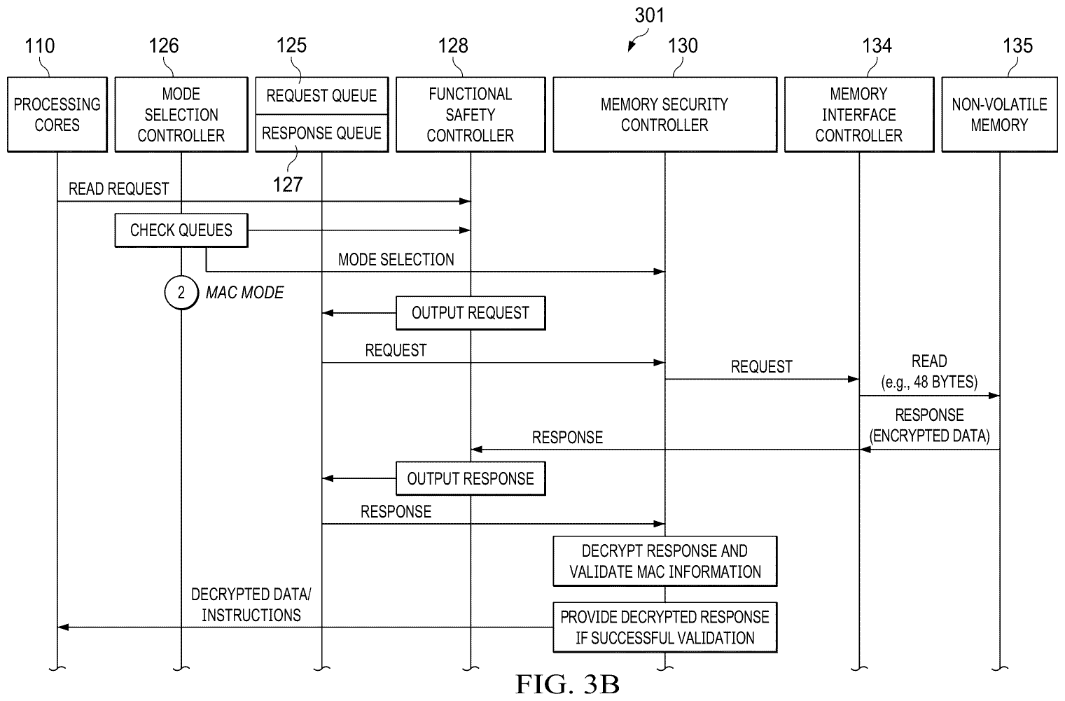

FIG. 4 illustrates an example block diagram of a system configurable to perform memory access and cryptography control in an implementation. FIG. 4 shows system 400, which includes and references elements of system 100, such as processing core 110-1, mode selection controller 126, memory security controller 130, memory interface controller 134, and non-volatile memory 135. System 400 also includes command duplicator 405, response error injection 406, response checker 407, request queue 125, command filter 411, command error injection 412, command checker 413, inline security interface controller 415, response duplicator 416, response queue 127, response filter 418, error interface 419, and status register 421. In various examples, command duplicator 405, command filter 411, command error injection 412, command checker 413, inline security interface controller 415, response duplicator 416, response filter 418, and error interface 419 may be included in a functional safety element of a system, such as functional safety controller 128 of system 100.

In various examples, system 400 is representative of a processing system that includes various hardware, software, and firmware elements configured to execute program instructions and to enable functionality based on the execution thereof. In various examples, the elements of system 400 are onboard a chip (i.e., a system-on-chip (SoC)). In some examples, some elements may be located off-chip relative to other elements onboard the chip, such as non-volatile memory 135.

Processing core 110-1 of system 400 may be representative of a processor, a processing core, or processing circuitry capable of executing software and firmware, such as program instructions (e.g., application code, loadable instructions, read-only data, execute-in-place XIP) code, and the like). Examples of the processing core 110-1 may include a microcontroller, a digital signal processors (DSP), a general purpose processing unit, a central processing unit (CPU), an application specific processor or circuit (e.g., ASIC), and one or more logic devices (e.g., FPGAs), as well as other types of processing devices, combinations, or variations thereof. In various examples, processing cores 110-1 may attempt to access non-volatile memory 135 to read from or write to non-volatile memory 135. Non-volatile memory 135, a non-volatile memory, may include one or more flash memory banks included to provide additional capacity to store instructions and data, such as XIP code, read-only data, secondary bootloader data, and other loadable instructions, accessible to processing core 110-1 via memory interface controller 134 and various safety and security components.

Mode selection controller 126, memory security controller 130, command duplicator 405, response error injection 406, response checker 407, request queue 125, command filter 411, command error injection 412, command checker 413, inline security interface controller 415, response duplicator 416, response queue 127, response filter 418, error interface 419, and status register 421 may be collectively referred to as safety and security components of system 400. These components may be representative of a subsystem (e.g., safety and security subsystem 124) configured to provide processing core 110-1 with access to non-volatile memory 135 via memory interface controller 134 for the execution of application code thereon as well as encryption and decryption of information (e.g., data, program instructions) being passed to and from non-volatile memory 135 via memory interface controller 134. In an example, these components may be coupled to receive access requests (e.g., reads, writes) from processing core 110-1, receive responses based on the access requests from non-volatile memory 135 via memory interface controller 134, and perform cryptographic operations and cryptographic functional safety operations on access requests to non-volatile memory 135 and returned access requests (responses) from non-volatile memory 135. Memory interface controller 134 may be configured to route the access requests to physical address spaces of non-volatile memory 135 based on the access requests and provide access to non-volatile memory 135 at the physical addresses.

Mode selection controller 126 may be representative of one or more processors, circuits, or devices coupled to command duplicator 405, command filter 411, and memory security controller 130 to control operations thereof. Mode selection controller 126 may also be coupled to request queue 125 and response queue 127. Specifically, in operation, mode selection controller 126 may be configured to identify a current state (e.g., enabled, disabled) (i.e., mode) of double pump functional safety circuitry (e.g., command duplicator 405, response duplicator 416) and memory security controller 130, identify a number of access requests in request queue 125, identify a number of responses in response queue 127, and enable or disable operations of the double pump functional safety circuitry and memory security controller 130 based on the numbers and the current operations thereof. In various examples, mode selection controller 126 may identify the current operational state of the components based on an indication of status register 421. For example, status register 421 may include a memory-mapped register (MMR) that includes indications of states of the double pump functional safety circuitry and memory security controller 130 at given times and with respect to a given access request and corresponding response.

When enabled to operate in a first mode based on control by mode selection controller 126, command duplicator 405, command filter 411, response duplicator 416, response filter 418, and memory security controller 130 may be configured to operate to duplicate, encrypt or decrypt (i.e., via a first set of security cores of memory security controller 130 (e.g. security cores 131)), validate, and filter access requests and responses using a first method of cryptographic functional safety (double pump functional safety). When enabled to operate in a second mode, duplicate and filter functions of command duplicator 405, command filter 411, response duplicator 416, and response filter 418 may be disabled, and memory security controller 130 may use the first set of security cores and a second set of security cores (e.g., MAC cores 132) capable of performing message authentication code (MAC) encryption and decryption to encrypt and decrypt access requests and corresponding responses, respectively.

To determine whether to enable cryptographic functional safety using the first mode or the second mode, mode selection controller 126 may be configured to determine a number of pending access requests associated with memory security controller 130, or respective cores thereof, in request queue 125 during a given mode and to determine a number of incoming responses from non-volatile memory 135 to memory security controller 130 in response queue 127. Each incoming response may correspond to an access request of the pending access requests. Based on the number of pending access requests and incoming responses in respective queues, mode selection controller 126 can determine whether non-volatile memory 135 may be slowing down overall operations of system 400 (i.e., is a bottleneck) or whether memory security controller 130 or the double pump functional safety circuitry may be slowing down operations of system 400 (i.e., is a bottleneck).

For example, if the number of pending access requests exceeds a threshold number, mode selection controller 126 may determine that non-volatile memory 135 and memory interface controller 134 might not be processing the access requests and providing responses to the access requests fast enough, such that non-volatile memory 135 and memory interface controller 134 are reducing processing efficiency, responsiveness, throughput, and the like of MCU 105. Thus, mode selection controller 126 may disable the second mode (MAC functional safety) and may enable the first mode (double pump functional safety). Contrarily, if the number of incoming responses exceeds a threshold number, mode selection controller 126 may determine that memory security controller 130, command duplicator 405, command filter 411, response duplicator 416, and response filter 418 might not be processing (e.g., duplicating, validating, filtering) and decrypting the access requests and responses fast enough, such that memory security controller 130 and the double pump circuitry are reducing processing efficiency, responsiveness, throughput, and the like of MCU 105. Thus, mode selection controller 126 may disable the first mode and enable the second mode and update status register 421 accordingly.

By way of a first example, in operation, processing core 110-1 provides an access request to the safety and security components of system 400 for access to non-volatile memory 135 based on the access request and decryption of information specified in the access request. More specifically, processing core 110-1 may provide the access request to command duplicator 405. The access request may correspond to a read request indicating a first set of data to be read from non-volatile memory 135. In this first example, the safety and security components of system 400 may be configured to operate in a first mode (e.g., double pump functional safety mode). In some examples, mode selection controller 126 may control some of the components of system 400 to operate in the first mode. In some examples, processing core 110-1 may direct mode selection controller 126 to control the components to operate in the first mode.

Based on being enabled to operate in the first mode, command duplicator 405 may be configured to duplicate the read request and add the read requests to request queue 125. Memory security controller 130 can obtain the read requests from request queue 125, record an indication of the first mode corresponding to the read requests, and provide the read requests to command checker 413 to validate the duplication performed by command duplicator 405. Command checker 413 may be configured to perform a comparison between the two read requests to validate the duplication. In some examples, command checker 413 may be configured to compare information such as the addresses of the read requests, the number of bytes of the read requests (e.g., the size), and protocol-specific information of each read request. Based on an unsuccessful verification, command checker 413 may output an indication thereof (e.g., an interrupt signal) to processing core 110-1 indicating a failure in the double pump functional safety operation. Based on successful verification, command checker 413 may provide the read requests to command filter 411 for filtering of one of the read requests (e.g., discarding).

Command filter 411 can filter the read requests such that command filter 411 provides one read request to inline security interface controller 415. Next, inline security interface controller 415 can perform additional security operations on the read request and provide the read request to memory interface controller 134. Then, memory interface controller 134 can access non-volatile memory 135 to obtain the first set of data indicated by the read request at a set of addresses of non-volatile memory 135 based on the read request.

Upon obtaining the first set of data, memory interface controller 134 can provide a response from non-volatile memory 135 including the first set of data to inline security interface controller 415. Inline security interface controller 415 can provide security operations on the response (e.g., malware detection) and provide the response to response duplicator 416. Response duplicator 416, based on operating in the first mode, can duplicate the response and add the responses to response queue 127. Memory security controller 130 can obtain the responses from response queue 127. Then, memory security controller 130 can utilize the first set of security cores (e.g., security cores 131) to decrypt each copy of the duplicated responses. Following decryption, memory security controller 130 can provide the decrypted responses to response checker 408 to validate the decryption. Response checker 408 may be configured to validate the decryption based on performing a comparison between the two decrypted responses to determine whether the decrypted information (e.g., the size of the response, the data or text of the response) is the same among the responses. Based on an unsuccessful verification, response checker 408 may be configured to output an indication thereof to processing core 110-1. Based on a successful verification, response checker 408 can provide the decrypted responses to response filter 418 for filtering.

Response filter 418 can filter the decrypted responses such that response filter 418 provides one encrypted read request to error interface 419. Error interface 419 may determine whether an error occurred during decryption or with the response, and if not, provide the response including the first set of decrypted data to processing core 110-1. If error interface 419 detects an error, error interface 419 can provide an indication thereof to processing core 110-1 if not already output by another element of system 400.

By way of a second example, in operation, processing core 110-1 provides an access request to the safety and security components of system 400 for access to non-volatile memory 135 based on the access request and decryption of information specified in the access request. More specifically, processing core 110-1 may provide the access request to command duplicator 405. The access request may correspond to a read request indicating a second set of data to be read from non-volatile memory 135. In this second example, the safety and security components of system 400 may be configured to operate in a second mode (e.g., MAC functional safety mode). In some examples, mode selection controller 126 may control the components to operate in the second mode. In some examples, processing core 110-1 may direct mode selection controller 126 to control the components to operate in the second mode.

Based on being enabled to operate in the second mode, command duplicator 405 may be configured to add the read request to request queue 125 without duplicating the read request. Memory security controller 130 can obtain the read request from request queue 125 and provide the read request to command checker 413. Command checker 413 can provide the read request to command filter 411, which might not perform filtering given the lack of duplication of the read request by command duplicator 405 based on operating in the second mode. Command filter 411 can provide the read request to inline security interface controller 415. Next, inline security interface controller 415 can perform additional security operations on the read request and provide the read request to memory interface controller 134. Then, memory interface controller 134 can access non-volatile memory 135 to obtain the second set of data indicated by the read request at a set of addresses of non-volatile memory 135 based on the read request.

Upon obtaining the second set of data, memory interface controller 134 can provide a response from non-volatile memory 135 including the second set of data to inline security interface controller 415. Inline security interface controller 415 can provide security operations on the response (e.g., malware detection) and provide the response to response duplicator 416. Response duplicator 416, based on operating in the second mode, can add the response to response queue 127 without duplication. Memory security controller 130 can obtain the response from response queue 127. Memory security controller 130 can utilize the first set of security cores (e.g., security cores 131) and the second set of security cores (e.g., MAC cores 132) to decrypt the response and perform functional safety validation thereof. More specifically, the first set of security cores may be configured to decrypt the second set of encrypted data of the response and provide the decrypted data to the second set of security cores. The second set of security cores may be configured to validate the MAC information associated with the decrypted data based on comparing the MAC information received in the response to the MAC information used to encrypt the second set of data.

Based on an unsuccessful validation of the MAC information or other information of the response (e.g., the size of the response, the data or text of the response), memory security controller 130 may be configured to output an indication thereof the processing core 110-1. Based on successful validation of both the MAC information and the other information of the response, memory security controller 130 may output the decrypted data to error interface 419 and bypass other elements of system 400 based on being enabled to operate in the second mode (e.g., response checker 408). In some examples, memory security controller 130 may still provide the decrypted response to response checker 408 despite being enabled to operate in the second mode. However, based on being enabled to operate in the second mode, response checker 408 can provide the decrypted responses to response filter 418, which might not provide filtering based on the lack of duplication of the response by response duplicator 416. Response filter 418 may then provide the encrypted response to error interface 419. Error interface 419 may determine whether an error occurred during decryption or with the response, and if not, provide the response including the second set of decrypted data to processing core 110-1. If error interface 419 detects an error, error interface 419 can provide an indication thereof to processing core 110-1.

Between the time that processing core 110-1 provides the read request as in the first example and the read request as in the second example, the safety and security components may perform cryptographic processes on other access requests related to different data. Before processing these other access requests, mode selection controller 126 may be configured to determine a number of pending access requests in request queue 125, determine a number of pending responses in response queue 127, and control the mode of command duplicator 405, command filter 411, response duplicator 416, response filter 418, and memory security controller 130 based on the determined numbers relative to respective thresholds. Thus, the mode of the safety and security components may change one or more times for processing of the other access requests occurring between the access requests of the above examples. For example, processing core 110-1 may provide the first read request indicating the first set of data at a first time and the second read request indicating the second set of data at a second time later than the first time. Accordingly, mode selection controller 126 may switch modes between subsequent access requests based on this example. Other combinations or variation of access requests, responses, and mode switching to enable different cryptographic operations may be contemplated.

In various examples, non-volatile memory 135 may further provide error checking indications to memory security controller 130 via memory interface controller 134, which may be provided to processing core 110-1 via interconnect 115. An example indication may include a MAC error, which may indicate an error in the encryption or decryption of an access request when components of system 400 operate in the second mode (MAC mode). Upon determining a MAC error, memory interface controller 134 can provide an indication to inline security interface controller 415, which can provide the MAC error indication to memory security controller 130 and/or to processing core 110-1. Based on receiving a MAC error indication, processing core 110-1 may be configured to retry the access request or interrupt operations.

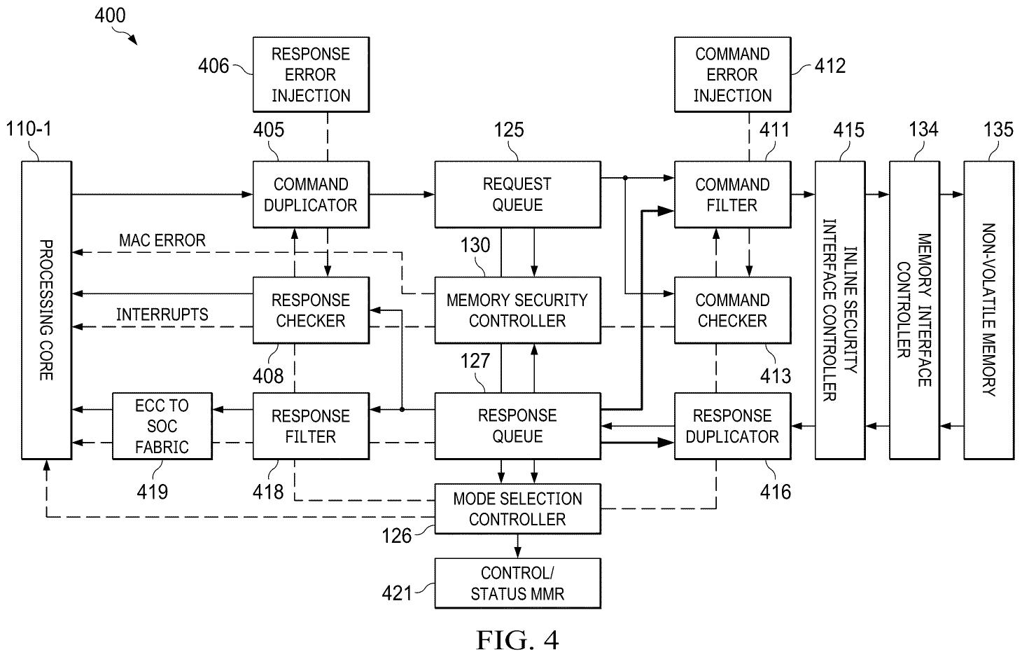

FIG. 5 illustrates an example flow chart for controlling cryptographic processes in an implementation. FIG. 5 includes method 500, which references elements of FIG. 1 and FIG. 4. Method 500 may be implemented by one or more components of a processing system, such as MCU 105 of FIG. 1 and system 400 of FIG. 4. Accordingly, method 500 may be implemented in hardware, firmware, and/or software, or combinations or variations thereof.

In operation 505, mode selection controller 126 may determine whether adaptive switching is enabled. Adaptive switching may refer to a mode of mode selection controller 126 that, when enabled, enables mode selection controller 126 to control cryptography modes of safety and security components of a system (e.g., functional safety controller 128, memory security controller 130). To enable adaptive switching, one of processing cores 110, such as processing core 110-1, may provide an enable signal (e.g., selection signal 123) to mode selection controller 126. In some examples, the enable signal may include an indication of which cryptography mode that mode selection controller 126 should enable as well.

Based on adaptive switching of mode selection controller 126 being disabled, in operation 510, mode selection controller 126 may enable a cryptography mode (e.g., MAC cryptography, double pump cryptography) based on an indication provided by processing core 110-1 via selection signal 123. In some examples, the mode indicated by and enabled by selection signal 123 may be determined based on processing core 110-1 executing program instructions (i.e., software enabled). In some examples, a value of selection signal 123 may be user-selected or predetermined.

Based on adaptive switching of mode selection controller 126 being enabled, in operation 515, mode selection controller 126 may be configured to determine a number of pending access requests associated with non-volatile memory 135. A pending access request may refer to an access request in an access request queue waiting to be encrypted by memory security controller 130. Memory security controller 130 may compare the number of pending access requests to a threshold number. In some examples, the threshold number may be a predetermined number based on a capacity of an access request queue (e.g., request queue 125). In response to determining that the number of pending access requests exceeds the threshold number, in operation 525, mode selection controller 126 can control the safety and security components to operate in a double pump functional safety mode to apply double pump cryptographic functional safety operations on access requests and corresponding responses. In response to determining that the number of pending access requests does not exceed the threshold number, in operation 530, mode selection controller 126 can control the safety and security components to operate in a MAC functional safety mode to apply MAC functional safety operations on the access requests and corresponding responses.

Further, based on adaptive switching of mode selection controller 126 being enabled, in operation 520, mode selection controller 126 may be configured to determine a number of incoming, pending responses associated with non-volatile memory 135. A response may refer to a returned information from non-volatile memory 135 to memory interface controller 134 based on the access request. Each response may be provided based on an access request, and thus, may be associated with a specific access request. Memory security controller 130 may compare the number of incoming responses to a threshold number. In some examples, the threshold number may be a predetermined number based on a capacity of a response queue (e.g., response queue 127). In some examples, this threshold number may be the same or different than the threshold number associated with the access request queue. In response to determining that the number of incoming responses exceeds the threshold number, in operation 530, mode selection controller 126 can control the safety and security components to operate in the MAC functional safety mode. In response to determining that the number of pending access requests exceeds the threshold number, in operation 525, mode selection controller 126 can control the safety and security components to operate in the double pump functional safety mode.

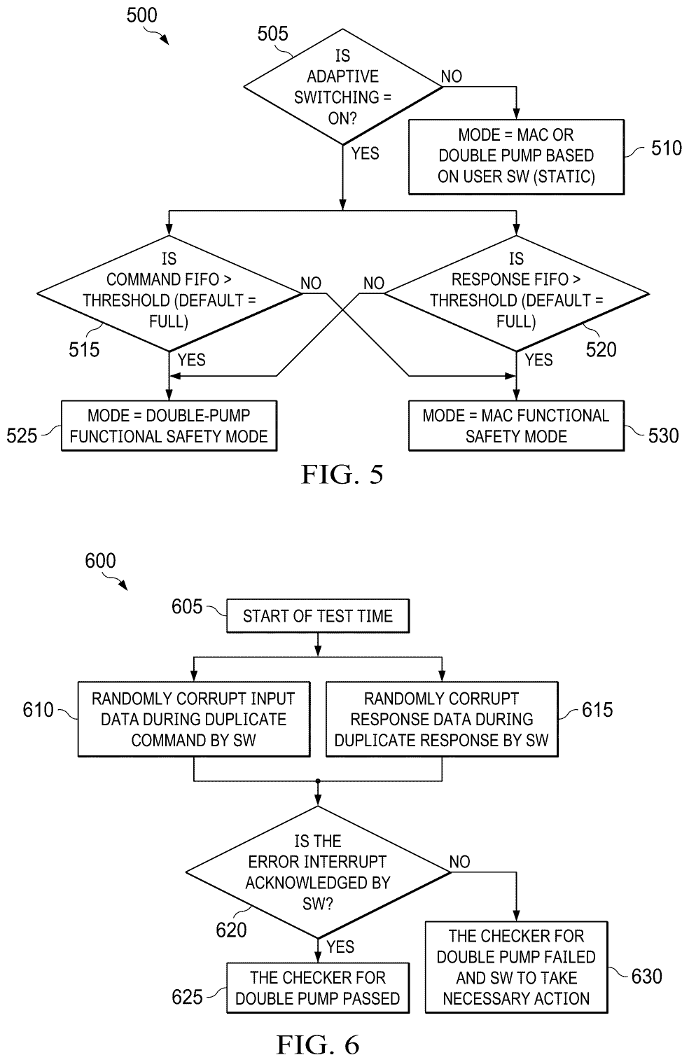

FIG. 6 illustrates an example flow chart for controlling cryptographic processes in an implementation. FIG. 6 includes method 600, which references elements of FIG. 1 and FIG. 4. Method 600 may be implemented by one or more components of a processing system, such as MCU 105 of FIG. 1 and system 400 of FIG. 4. Accordingly, method 600 may be implemented in hardware, firmware, and/or software, or combinations or variations thereof.

In various examples, method 600 may include a series of steps related to testing of functionality of components of a system. As such, the steps of method 600 might not refer to or be used during run-time operations of a system. In some examples, however, the testing steps may be employed intermittently during run-time operations to ensure correct proper operation of safety and security components of a system (e.g., safety and security subsystem 124 and components thereof).

In operation 605, processing core 110-1 begins a test of safety and security components of a system. At this step, processing core 110-1 may provide an access request to the safety and security components and may further enable mode selection controller 126 to control the safety and security components to operate in the double pump functional safety mode. In this mode, command duplicator 405 can duplicate the access request and provide the duplicated requests to command checker 413, among other components.

In operation 610, processing core 110-1 utilizes command error injection 412 to randomly corrupt data and provide the corrupted data to command checker 413. During this step, command checker 413 may be configured to receive duplicated access requests from command duplicator 405 and perform a validation operation using the corrupted data and the duplicated access requests. This may entail determining whether command checker 413 identifies the corrupted data and whether the corrupted data affects each copy of the duplicated access requests. Thus, in operation 620, command checker 413 may acknowledge an error based on a validation that indicates that command checker 413 received corrupted data. Based on acknowledging the error, in operation 625, command checker 413 may provide an indication of the acknowledgement to processing core 110-1. As a result, processing core 110-1 can determine that command checker 413 has successfully passed the test and that the double pump functional safety mode is functioning correctly.

Similarly, in operation 615, processing core 110-1 utilizes response error injection 406 to randomly corrupt data associated with a response from non-volatile memory 135 based on the access request and provide the corrupted data to response checker 408. During this step, response checker 408 may be configured to receive duplicated responses from response duplicator 416 and perform a validation operation using the corrupted data and the duplicated responses. This may entail determining whether response checker 408 identifies the corrupted data and whether the corrupted data affects each copy of the duplicated responses. In operation 620, response checker 408 may acknowledge an error based on a validation that indicates that response checker 408 received corrupted data. Based on acknowledging the error, in operation 625, response checker 408 may provide an indication of the acknowledgement to processing core 110-1. As a result, processing core 110-1 can determine that response checker 408 has successfully passed the test and that the double pump functional safety mode is functioning correctly.

However, in operation 620, if either command checker 413 or response checker 408 does not acknowledge an error, or in other words, does not identify received corrupted data, command checker 413 and/or response checker 408 might not provide an acknowledgement to processing core 110-1. As a result, processing core 110-1 can determine that the double pump circuitry (e.g., functional safety controller 128) has failed the test and may interrupt operations.

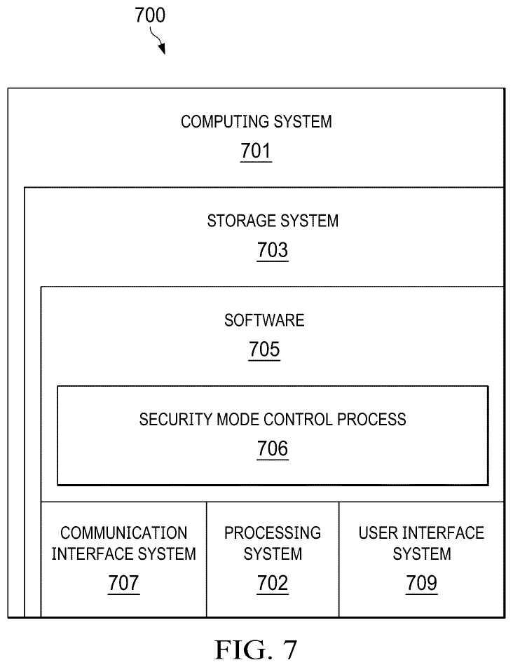

FIG. 7 illustrates computing system 701 to perform cryptographic processes related to memory access according to an implementation of the present technology. Computing system 701 is representative of any system or collection of systems with which the various operational architectures, processes, scenarios, and sequences disclosed herein for memory access control may be employed. Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709 (optional). Processing system 702 is operatively coupled with storage system 703, communication interface system 707, and user interface system 709. Computing system 701 may be representative of a cloud computing device, distributed computing device, or the like.

Processing system 702 loads and executes software 705 from storage system 703. Software 705 includes and implements security mode control process 706, which is representative of any of the access request and response duplication, filtering, encryption, decryption, and statistics gathering processes discussed with respect to the preceding Figures. When executed by processing system 702 to provide access functions, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including security mode control process 706) may be implemented in program instructions and among other functions may, when executed by processing system 702, direct processing system 702 to operate as described with respect to the various operational scenarios, sequences, and processes illustrated herein. For example, software 705 may include program instructions for selecting a cryptography mode as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to provide memory access as described herein. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

While some examples provided herein are described in the context of a system-on-chip, processor, processing core, microcontroller unit, circuitry, environment, or the like, the memory access methods, techniques, and systems described herein are not limited to such examples and may apply to a variety of other processes, systems, applications, devices, and the like. Aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some examples,” “according to some examples,” “in the examples shown,” “in other examples,” and the like generally mean the particular feature, structure, or characteristic following the phrase is included in at least one implementation of the present technology, and may be included in more than one implementation. In addition, such phrases do not necessarily refer to the same example or different examples.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A device, comprising:
a memory security controller configured to operate in a first functional safety mode or a second functional safety mode;
a security mode selection controller coupled to the memory security controller; and
a memory interface controller coupled to the memory security controller and the security mode selection controller and configured to couple to a non-volatile memory;
wherein the security mode selection controller is configured to:
determine a number of pending access requests associated with the memory security controller;
determine a number of incoming responses from the non-volatile memory to the memory security controller; and
select between the first functional safety mode and the second functional safety mode based on at least one of the number of pending access requests or the number of incoming responses.

2. The device of claim 1, wherein the security mode selection controller is configured to:
direct the memory security controller to operate in the first functional safety mode based on the number of incoming responses exceeding a first threshold number; and
direct the memory security controller to operate in the second functional safety mode based on the number of pending access requests exceeding a second threshold number.

3. The device of claim 2, wherein the memory security controller is configured to, in the first functional safety mode, duplicate at least one of a request or a response and compare copies of the least one of the request or the response.

4. The device of claim 3, wherein the memory security controller is configured to, in the second functional safety mode, compare at least a portion of a decrypted response to a Message Authentication Code (MAC) value.

5. The device of claim 3, wherein the memory security controller is configured to, in the first functional safety mode:
duplicate the request;
encrypt information associated with each copy of the request; and
provide a subset of the copies of the request to the memory interface controller.

6. The device of claim 5, wherein the memory security controller is configured to, in the first functional safety mode:
duplicate the response;
decrypt information associated with each copy of the response; and
provide a subset of the copies of the response to one or more processing cores.

7. The device of claim 1, wherein the pending access requests comprise read requests and write requests, and wherein the incoming responses comprise data or instructions corresponding to the pending access requests.

8. A system, comprising:
one or more processing cores;
an interconnect coupled to the one or more processing cores;
a memory security controller;
a security mode selection controller coupled to the memory security controller; and
a memory interface controller coupled to the memory security controller and the security mode selection controller and configured to couple to a non-volatile memory;
wherein the security mode selection controller is configured to:
determine a number of pending access requests associated with the memory security controller;
determine a number of incoming responses from the non-volatile memory to the memory security controller; and
control which cryptographic functional safety process is applied to at least one of a request or a response based on at least one of the number of pending access requests or the number of incoming responses.

9. The system of claim 8, wherein to control which cryptographic functional safety process is applied by the memory security controller, the security mode selection controller is configured to:
direct the memory security controller to perform a first cryptographic functional safety process on the at least one of the request or the response based on the number of incoming responses exceeding a first threshold number; and
direct the memory security controller to perform a second cryptographic functional safety process on the at least one of the request or the response based on the number of pending access requests exceeding a second threshold number.

10. The system of claim 9, wherein the first cryptographic functional safety process includes duplicating the at least one of the request or the response.

11. The system of claim 10, wherein the second cryptographic functional safety process includes comparing at least a portion of a decrypted response to a Message Authentication Code (MAC) value.

12. The system of claim 10, wherein to perform the first cryptographic functional safety process, the memory security controller is configured to:
duplicate the request to produce copies of the request;
encrypt information associated with each of the copies of the request; and
provide a subset of the copies of the request to the memory interface controller.

13. The system of claim 12, wherein to perform the first cryptographic functional safety process, the memory security controller is configured to:
duplicate the response to produce copies of the response;
decrypt information associated with each of the copies of the response; and
provide a subset of the copies of the response to the one or more processing cores.

14. The system of claim 8, wherein the pending access requests comprise read requests and write requests, and wherein the incoming responses comprise data or instructions corresponding to the pending access requests.

15. A method, comprising:
receiving, from one or more processing cores, access requests for data stored in a non-volatile memory device;
determining a number of pending access requests of the access requests associated with the non-volatile memory device;
determining a number of incoming responses from the non-volatile memory device; and
selecting which cryptographic functional safety process to apply to at least one of a request or a response based on at least one of the number of pending access requests or the number of incoming responses.

16. The method of claim 15, wherein controlling which cryptographic functional safety process to apply comprises:
selecting to apply a first cryptographic functional safety process to the at least one of the request or the response based on the number of incoming responses exceeding a first threshold number; and
selecting to apply a second cryptographic functional safety process to the at least one of the request or the response based on the number of pending access requests exceeding a second threshold number.

17. The method of claim 16, wherein applying the first cryptographic functional safety process comprises duplicating the at least one of the request or the response and comparing copies of the at least one of the request or the response, and wherein applying the second cryptographic functional safety process comprises comparing at least a portion of a decrypted response to a Message Authentication Code (MAC) value.

18. The method of claim 17, wherein applying the first cryptographic functional safety process comprises:
duplicating the request;
encrypting information associated with each copy of the request; and
providing a subset of the copies of the request to a memory interface controller.

19. The method of claim 18, wherein applying the first cryptographic functional safety process further comprises:
duplicating the response;
decrypting information associated with each copy of the response; and
providing a subset of the copies of the response to the one or more processing cores.

20. The method of claim 15, wherein the pending access requests comprise read requests and write requests, and wherein the incoming responses comprise data or instructions corresponding to the pending access requests.
